(19) United States
(12) Patent Application Publication
(10) Pub. No.: US 2007/0025880 A1
(43) Pub. Date: Feb. 1, 2007

(54) Device for removing and depositing droplets of at least one liquid, method of using the device and servo system for said method

(76) Inventor: Moussa Hoummady, Besancon (FR)

Correspondence Address: CLARK & BRODY, 1090 VERMONT AVENUE, NW, SUITE 250, WASHINGTON, DC, 20005, US

(21) Appl. No.: 10/565,432

(22) PCT Filed: Jun. 17, 2003
(86) PCT No.: PCT/FR03/01843

§ 371 Date: Jun. 19, 2006

(51) Int. Cl. B01L 3/02

(52) U.S. Cl. 422/100

(57) ABSTRACT

The invention proposes the drawing and deposition of liquid droplets while preventing any contact with the ambient air before the liquid is deposited, by providing a device which can be closed, and which can be supplied to the user in the form of a pre-filled cartridge.

In a preferred embodiment of the invention, the device for drawing and depositing droplets (100) of at least one liquid (32) comprises an outer tube (101) with an opening (107) at one of the ends thereof, a flange (109) defining the opening (107), a rod (111, 211, 221) which can slide inside said outer tube (101), an inner volume (117) between said rod (111, 211, 221) and the outer tube (101), a capillary-sized open port (119) in the wall of said outer tube (101), and a closure element (113, 213) for closing said opening (107), connected to said rod (111, 211, 221). According to the invention, when said rod (111, 211, 221) is in a forward end position, said closure element (113, 213) comes into contact with the flange (109) and thus hermetically closes said opening (107) and, when said rod is not in this end position, a capillary-sized passage (115) enables the inner volume (117) to communicate with the outside.

This invention relates to a device for drawing and depositing droplets of at least one liquid and a method for using this device, as well as a control system enabling this method to be controlled.

This invention in particular enables reagents and biological solutions with a predetermined volume on the order of a nanoliter, with an uncertainty on the order of around ten picoliters to be drawn and deposited.

Research in genomics, proteomics and more generally biology and pharmacy have led to the development of integrated analysis systems (biochips), with a strong tendency toward increasing the number of tests per surface unit, for example on the order of 1000 to 10,000 per cm². This requires the manipulation and delivery, in specific places, of small but controlled droplets, so as to form a high-density array which serves as a substrate for multiple tests.

A plurality of existing devices enable droplets with a radius of several hundred μm, corresponding to volumes of several nanoliters, to be formed.

For example, documents U.S. Pat. No. 5,807,522 and U.S. Pat. No. 6,101,946 describe devices based on a metal needle of which the tip is split like that of a pen. The drawing and retention in the slot of the liquid to be deposited is achieved by capillarity, and the deposition is achieved by contact with the test substrate.

These techniques have major disadvantages:
lack of regularity of the volumes deposited,
fragility and wear of the needles,
low drawing capacity, which necessitates frequent refilling,
shape of droplets determined by the shape of the tip,
rapid evaporation of the liquid, which causes a significant variability of the concentration when said liquid is a solution, and
difficulty of cleaning (technique based on ultrasound, which eventually causes deterioration of the needle).

The following documents also describe the prior art:
document WO 99 36760 describes a device using a ring and a full needle. A film of the liquid to be deposited is formed inside the ring, which acts as a vessel; the needle; the needle then passes through the liquid film and creates a deposit by dabbing; the disadvantages of this method are the same as those of the previous method, namely an irregular deposit and significant evaporation of the liquid; in addition, this technique has very limited potential for miniaturisation;
document WO 00 13796 describes a device for deposition by contact with a liquid contained in a vessel and brought to a printing point by a capillary die, in which the rapid evaporation of the liquid is prevented, but the problems of wear of the point, irregular deposit and closure and washing difficulties remain;
document WO 99 04896 describes a device for deposition by contact with a liquid which adheres to a frusto-conical tip, which is optionally fluted, wherein said tip is connected to a spring enabling the value of the force exerted by the tip on the deposition surface to be set. The main disadvantages of this method are due to the evaporation of the liquid, the low sampling capacity and the difficulty of precisely controlling the amount deposited, as the only control parameter is the duration of contact between the tip and the surface;
document U.S. Pat. No. 6,024,925 describes a device based on microsampling pipettes held by springs and filled by capillarity; the liquid is delivered by applying a positive pressure in a chamber to which the pipettes are connected;
document U.S. Pat. No. 6,235,473 describes a deposition device similar to a felt-tipped pen, which obviously has problems of liquid evaporation and regularity of the deposit, as well as a device comprising a needle valve, which opens to allow the liquid to exit when the tip is applied to the deposition surface; however, said valve is held closed only by weight, and the device must therefore be kept in vertical position.

To overcome the aforementioned disadvantages, the invention proposes the prevention of any contact with the ambient air before the liquid is deposited, by providing a device that can be closed, and that can advantageously be provided to the user in the form of a pre-filled cartridge.

Such a device advantageously allows the amount of liquid drawn or deposited to be adjusted with a precision on the order of less than a nanoliter. When a plurality of these devices are combined in a single drawing/deposit head, each of said devices can advantageously be controlled individually.

An object of this invention is more specifically a device for drawing and depositing droplets of at least one liquid, comprising:
an outer tube with an opening at one of its ends;
a capillary-sized port in the wall of said outer tub, enabling a pressure equal to the atmospheric pressure to be maintained inside said outer tube;
a flange defining said opening;
a rod capable of sliding inside said outer tube;
an inner volume between said rod and the outer tube;
an element for closing said opening connected to said rod, and in which, when said rod is in a forward end position, said closure element comes into contact with the flange and thus hermetically closes said opening while, when the rod is not in this end position, a capillary-sized passage enables the inner volume to communicate with the outside.

Said closure element is preferably maintained in said forward position by means for applying an elastic force.

The cross-section of said passage varies continuously according to the relative position of said rod with respect to said outer tube, between 0 and a maximum value, reached when said rod is in said fully retracted position.

According to preferred embodiments:
the maximum cross-section of said passage is on the order of 10⁻⁸ m² with an uncertainty on the order of 1%, so that the volume of the deposited droplets is on the order of a nanoliter with an uncertainty on the order of 10 picoliters;
said closure element is a tip, preferably conical, or a ball;
the means for applying an elastic force are selected from a spring, an elastic beam member, an elastic membrane, and a block of elastomer material;
the means for applying an elastic force connect the end of the opposite rod to the opening of the outer tube or to a second rod, collinear with the first;
the closure element is secured to said rod;
the means for applying an elastic force connect the closure element to the end of the rod on the side of the opening.

According to advantageous features:
the device also includes a position sensor that enables the position of said rod inside said outer tube to be measured;
the device also includes an actuator that enables the position of said rod inside said outer tube to be adjusted;
the sensor and actuator consist of a solenoid and at least one portion of said rod made of a material having a relative magnetic permeability μᵣ substantially greater than 1;
the device can consist at least partially of a material selected from stainless steel, glass, a plastic material and a polymer;
the device can include protective coatings on at least one portion of the surfaces capable of coming into contact with at least one liquid to be drawn or deposited, respectively;
the device can include hydrophobic or hydrophilic coatings on at least one portion of the surfaces capable of coming into contact with at least one liquid to be drawn or deposited;
at least one of said coatings preferably consists of a hydrophilic material, such as tungsten;
the capillary-sized port is small enough to prevent a liquid capable of being drawn or deposited from passing through it, and can be stopped so as to insulate the inner volume from the environment;
the device can be connected to a container containing an inert gas;
the pressure of said inert gas is adjustable so that it is possible to draw or deposit a liquid with the assistance of the pneumatic effect;
the device is attached to a translation system enabling it to be moved in the three dimensions with micrometric precision, with the translation system being capable of being controlled by a computer.

The device is advantageously constituted by a cartridge that is pre-filled with a liquid.

Another object of this invention is a drawing and deposit head consisting of a plurality of said devices, so as to enable an array of droplets of at least one liquid to be deposited.

The amount of said liquid drawn or deposited by each device belonging to said drawing and deposit head can be controlled individually.

The invention also relates to a method for drawing at least one liquid using the aforementioned device, and comprising at least the following steps:
immersing said device in a container containing the liquid;
retracting said closure element so as to open the passage, and filling said inner volume by means of hydrostatic pressure and capillarity; and
extracting said device and moving said closure element forward so as to close the passage.

The retraction of said closure element is advantageously caused by the pressure exerted by said closure element on the base of said container.

In another embodiment of said method, the retraction of said closure element is caused by the actuator.

Another object of this invention is a method for drawing at least one liquid using the aforementioned device, and comprising at least the following steps:
moving said opening at the end of said device toward the surface of said liquid to be drawn;
retracting said closure element by the actuator so as to open the passage, and filling said inner volume by means of capillarity forces alone.

The method applies in particular to the case in which the liquid is contained in a microwell.

In this drawing method, the amount of said liquid that is drawn is controlled by adjusting the position of said rod inside said outer tube, and consequently the cross-section of said passage.

Another object of this invention is a method for deposition by contact with at least one liquid using a device as described above, and comprising at least the following steps:
positioning said device at the vertical of the point of the deposition surface where the deposit is to be provided;
placing said closure element in contact with said deposition surface, and opening said passage by means of the pressure exerted by said closure element on said contact surface;
depositing a controlled amount of said liquid by means of the combined forces of adhesion of said liquid to the deposition surface, capillarity and weight; and
lifting said device and moving said closure element forward so as to close the passage.

This invention also relates to a contactless method for depositing at least one liquid using the device defined above, and comprising at least the following steps:
positioning said device at the vertical of the point of the deposition surface where the deposit is to be provided;
retraction of said closure element by means of said actuator, which causes said passage to open; and

moving said closure element forward so as to close the passage, and depositing a droplet of said liquid by means of the combined effect of the weight and the plunger effect caused by the forward movement of said closure element.

In these deposition methods, the amount of liquid that is deposited is controlled by adjusting the position of said rod inside said outer tube, and, consequently, the cross-section of said passage.

Another aspect of this invention is a method for washing such a device, consisting of the injection into said device of a pressurised detergent liquid through the opening, with the removal of said detergent liquid being performed by suction via the passage, which is held open by retracting said closure element.

The invention also relates to a control system for adjusting the amount of liquid drawn or deposited, in which the translation system presses the closure element against the base or said deposition surface with a constant force, which can optionally be zero, and in which:
the relative position of said rod with respect to said outer tube is determined by the sensor;
said relative position is compared to its target value, calculated on the basis of the amount of liquid to be drawn or deposited;
the actuator brings said relative position close to said target value.

According to an alternative of this control system for adjusting the amount of liquid drawn or deposited, the translation system presses said closure element against the base or said deposition surface with a variable force.

Other features, details and advantages of the invention will become clear from the following description with reference to the appended drawings given by way of example, which show:

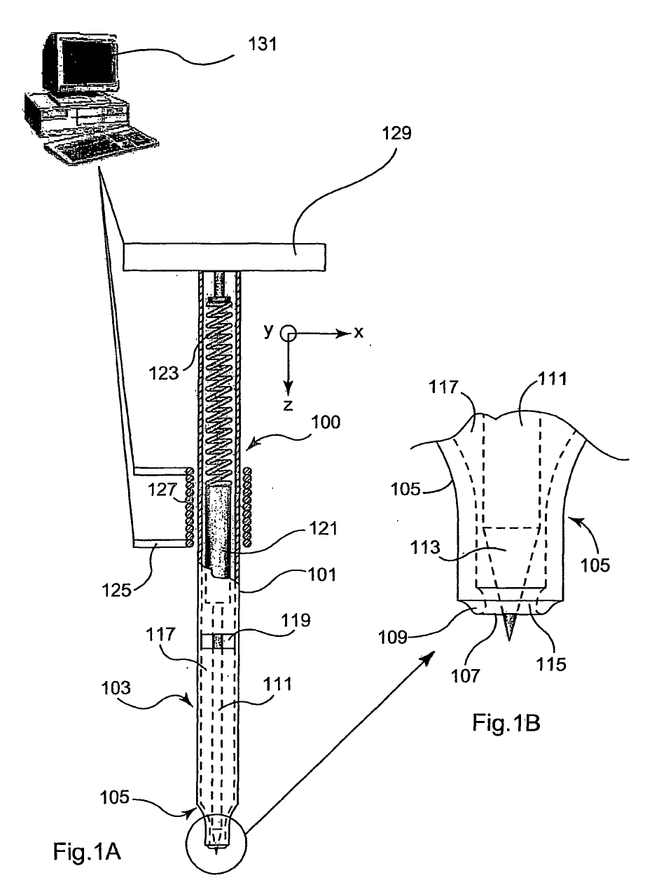

FIG. 1A, a cross-section view of an example of a device for drawing and depositing according to this invention;

FIG. 1B, an enlargement of the region near the open end of the aforementioned device;

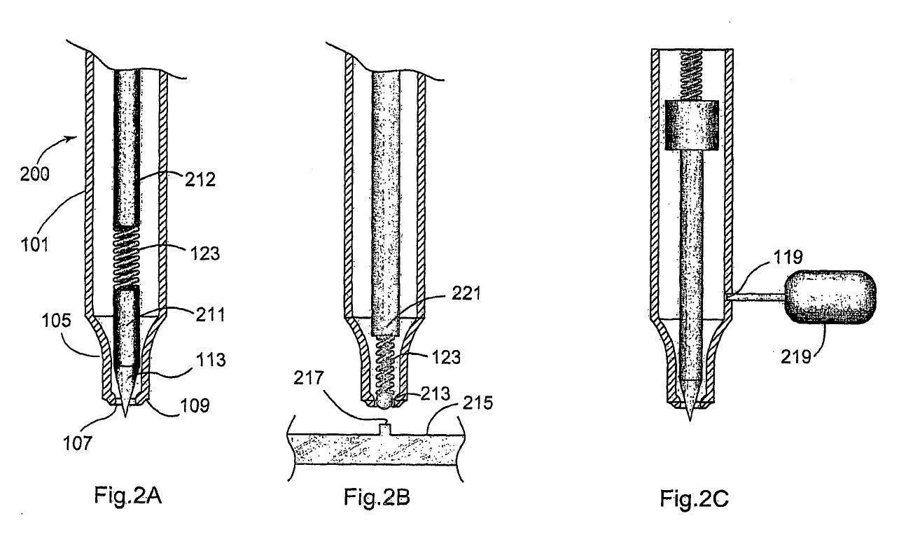

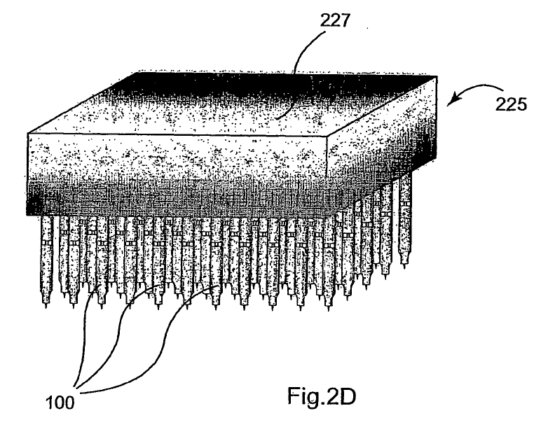

FIGS. 2A, 2B and 2C, three alternatives of the device according to FIG. 1A;

FIG. 2D, a drawing and deposit head consisting of a plurality of these devices;

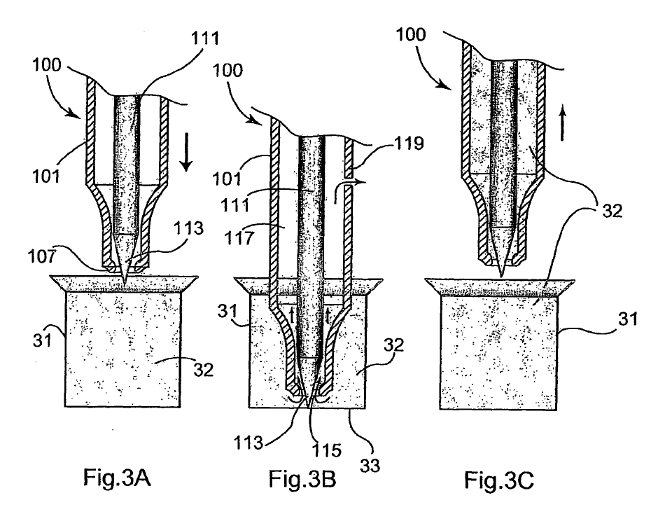

FIGS. 3A to 3C, the three steps of a method for implementing said device for drawing a predetermined amount of a liquid;

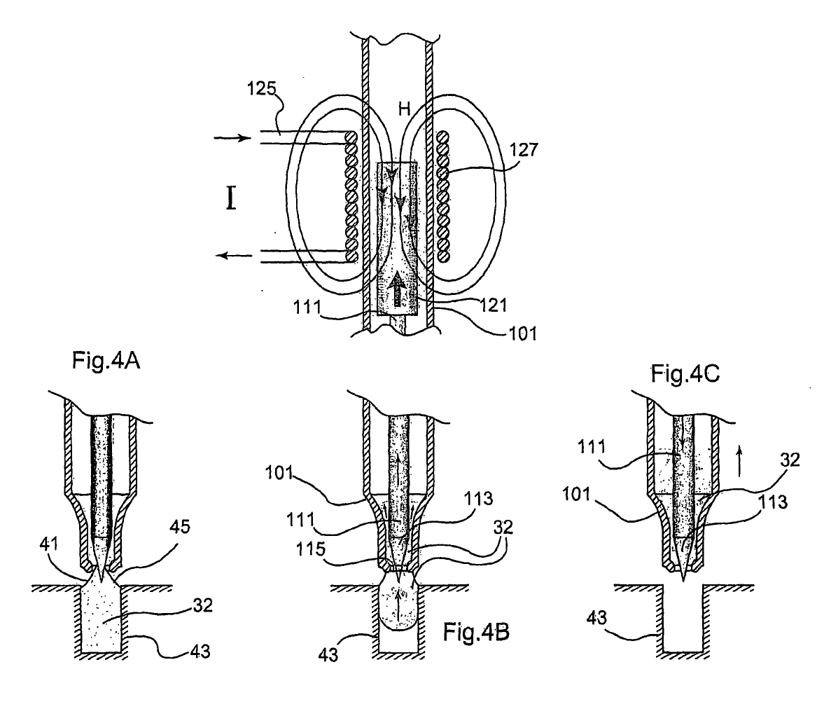

FIGS. 4A to 4C, the steps of an alternative of said drawing method, suitable for the case in which the liquid is contained in a microwell;

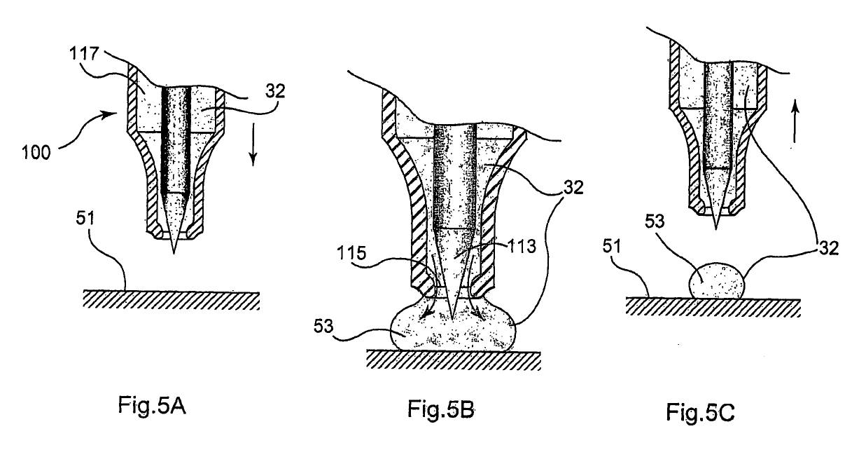

FIGS. 5A to 5C, the steps of a method for implementing said device for depositing a predetermined amount of a liquid on a deposition surface, consisting of placing said device in contact with said deposition surface;

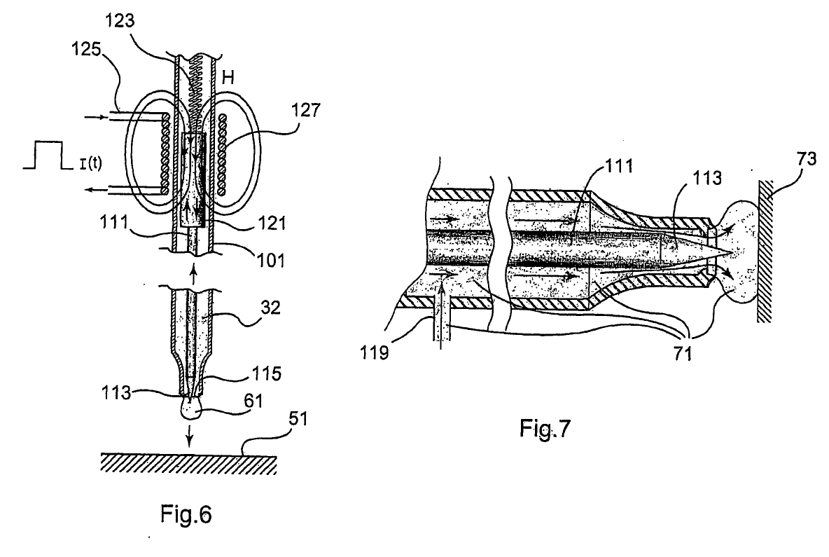

FIG. 6, an alternative of said deposition method, performed without contact;

FIG. 7, the washing of said device shown in a longitudinal cross-section view, enabling contamination between different liquids drawn and/or deposited by the same device to be prevented;

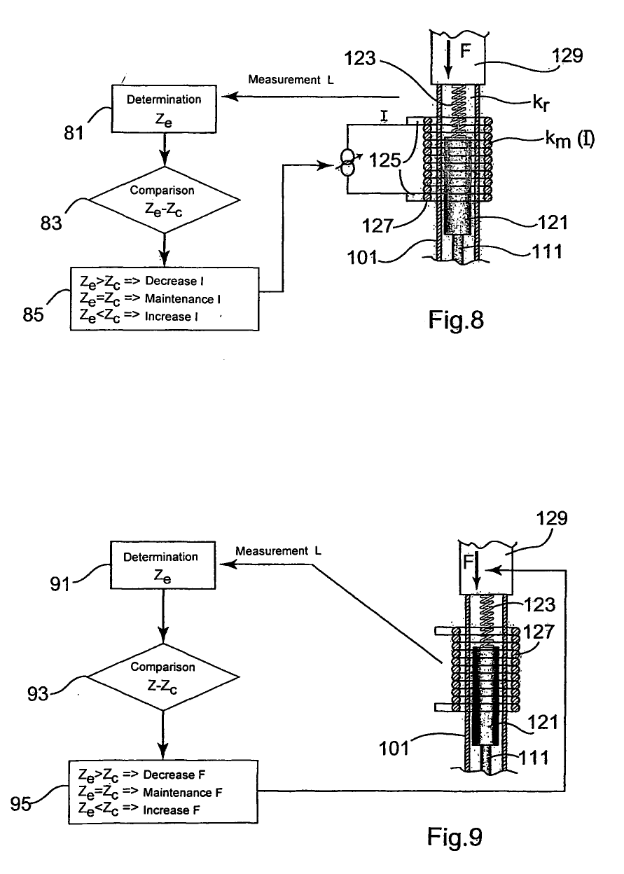

FIG. 8, a control system control algorithm for controlling the amount of liquid drawn and or deposited by the methods shown in FIGS. 3A to 3C, 4A to 4C, 5A to 5C and 6; and

FIG. 9, a control system control algorithm for controlling the amount of liquid drawn and or deposited by the methods shown in FIGS. 3A to 3C and 5A to 5C.

FIG. 1 shows a device 100 for drawing and depositing droplets of at least one liquid comprising an outer tube 101 consisting of a cylindrical body 103 and a tapered terminal portion 105.

The end of said terminal portion 105 comprises an opening 107 defined by a flange 109 in the form of a lip. The inside of said outer tube 101 includes a cylindrical rod 111, capable of sliding, with a conical point 113. As the diameter of the base of said conical point 113 is larger than that of said opening 107, said cylindrical rod 111 is locked inside said outer tube 101.

When said rod 111 is in a so-called fully forward end position, said conical point 113 is in contact with the flange 109 and thus hermetically closes said opening 107; in addition, a passage 115 of microscopic size enables the outside to communicate with the inner volume 117 between said rod 111 and the outer tube 101. The cross-section of said passage 115 varies continuously on the basis of the relative position Z of said rod 111 with respect to said outer tube 101, between 0 and a maximum value, reached when said rod 111 is in the second, so-called fully retracted, end position. More specifically, as said point 113 has a conical form, the cross-section of said passage 115 is quadratically dependent on Z.

The maximum value of the volume deposited is advantageously on the order of 1 nanoliter, with an uncertainty on the order of 10 picoliters. To achieve this result, the cross-section of the passage 115 reaches a maximum value on the order of 10⁻⁸ m² with an uncertainty on the order of 1%.

Regardless of the position of said rod 111, the inner volume 117 is maintained in contact with the outside by a capillary-sized port 119, which opens into the outer tube 101 in a position distant from said terminal portion 105, of which the function is to balance the pressure inside and outside said tube 101.

The end of said rod 111 opposite said point 113 is attached to a cylinder 121 made of a magnetic material (i.e. having a relative magnetic permeability μᵣ substantially greater than 1) with a larger diameter, which connects said rod 111 to means for applying an elastic force, such as the spring 123, which holds said rod 111 in its most forward position.

Around said outer tube 101, in correspondence with said cylinder 121, a wire 125 is wound to form a solenoid 127; when said rod 121 is in its fully forward position, the cylinder 121 is partially inside said solenoid 127; when said rod 111 is in its fully retracted position, the cylinder 121 is entirely inside said solenoid 127. As the cylinder 121 consists at least partially of a magnetic material, the inductance of said solenoid 127 is dependent on the relative position Z of said rod 111 with respect to said outer tube 101; the solenoid 127 therefore functions as a position sensor. The inductance can be measured by a method known to a person skilled in the art of electronics or electrical engineering.

An electrical current that circulates in the solenoid 127 creates a magnetic field that exerts an attractive force on the cylinder 121. The solenoid 127 then functions as an actuator, acting on the relative position Z of said rod 111 with respect to said outer tube 101.

The positioning of said device 100 is performed with micrometric precision by an x-y-z translation system 129 to which the outer tube 101 is attached.

The methods for drawing and depositing at least one liquid are controlled by a computer 131, which acts on the translation system 129 and the solenoid 127.

FIG. 2A shows a detail of another specific embodiment of this invention. In the device 200, inside an outer tube 101, there are two collinear rods 211 and 212. Rod 211, which is relatively short, has a conical point 113 and can slide inside the outer tube 101, while rod 212 is stationary. A spring 123 connects the two rods 211 and 212 and holds said rod 211 in its most forward position. As in the case of FIG. 1, said conical point 113 is in contact with a flange 109 and thus hermetically closes an opening 107.

In the specific embodiment shown in FIG. 2B, the short rod 211 and the point 113 are replaced by a ball 213. Said ball 213 is connected to the rod 221 by means of the spring 123. To facilitate the retraction of said ball 213, the deposition surface 215 can comprise protuberances 217 in the places where drops must be deposited.

The port 119 constitutes the only point of contact between the liquid contained in said devices 100 and 200 and the ambient air. If this must be avoided, for example, to prevent oxidation of said liquid, it is possible to connect the port 119 to a container 219 containing an inert gas, for example Argon, maintained at a pressure of 1 atmosphere, as shown in FIG. 2C. The control of the pressure of the gas in the container 219 also enables a pneumatic effect to be used to assist in the drawing and deposition of the liquid.

A drawing and deposit head 225, consisting of a matrix of devices 100 of the type shown in FIG. 1A attached to a support 227, is shown in FIG. 2D. Such a composite head allows for the simultaneous deposition of an array of droplets such as those shown in FIGS. 11A and 11B. Owing to the actuator 127, the amount of liquid deposited by each device belonging to the head 225 can be controlled individually.

FIGS. 3A to 3C show the various steps of a method for drawing and depositing liquid droplets, which uses the device of the present invention.

The device 100 is inserted (FIG. 3A) into a container 31 that contains the liquid 32 to be drawn. As the point 113 of the rod 111 hermetically closes the opening 107 of the outer tube 101, the liquid 32 cannot penetrate the inside of said device 100.

Said point 113 comes into contact (FIG. 3B) with the base 33 of said container 31 and is retracted with respect to said outer tube 101, opening the passage 115 which enables the inner volume 117 to communicate with the container 31. One of the control systems described in FIGS. 8 and 9 enables the degree of opening of said passage 115 to be adjusted. The combined effect of the hydrostatic pressure (communicating vessels principle) and capillarity forces the liquid 32 to penetrate the inner volume 117 by the passage 115. The port 119 enables air contained in the inner volume 117 to exit, and said volume can thus be filled with said liquid 32. The control of the degree of opening of said passage 115 and of the opening time enable the device to be filled with a predetermined amount of said liquid 32.

When said predetermined amount of said liquid 32 has been drawn (FIG. 3C), the device 100 is extracted from said container 31. Said point 113 closes said passage 115 so as to prevent said liquid 32 from leaking.

FIGS. 4A to 4C show the various steps of an alternative of the drawing method, suitable for the case in which the liquid is contained in a microwell.

In FIG. 4A, the device 100 approaches surface 41 of a liquid 32 contained in a microwell 43 until the point 113 of the rod 111 comes into contact with said surface 41. The liquid 32 adheres to said point 113 and forms a concave meniscus 45.

According to FIG. 4B, an electrical current I is injected into the solenoid 127 so as to create a magnetic field H so as to lift said point 113 and thus open the passage 115. The liquid is suctioned solely by capillarity; the inner surface of said device must therefore be sufficiently hydrophilic with respect to that of said microwell 37.

FIG. 4C shows that, when all of the liquid 32 contained in the microwell 43 has been drawn, the device 100 is lifted and said point 113 closes said passage 115 so as to prevent said liquid 32 from leaking.

FIGS. 5A to 5C show the various steps of a method for depositing a predetermined amount of a liquid onto a deposition surface, consisting of placing said device in contact with said deposition surface.

In FIG. 5A, the device 100 is positioned on the deposition surface 51, at the vertical of the point where a predetermined amount of said liquid 32 is to be deposited.

FIG. 5B shows the device 100 lowered. When said point 113 touches said deposition surface 51, the passage 115 opens, as in the drawing phase (FIG. 3B). The combined effect of the forces of capillarity, the adherence of said liquid 32 with said deposition surface 51 and the weight enable a predetermined amount 53 of said liquid 32 to be deposited onto said deposition surface 51. The volume of said predetermined amount 53 can be controlled by adjusting the degree of opening of said passage 115. The port 119 allows air to penetrate the inner volume 117 so as to maintain a constant pressure inside said device 100.

In FIG. 5C, once said predetermined amount 53 of said liquid has been deposited, the device 100 is removed from said deposition surface 51. Said point 113 then closes said passage 115 so as to prevent said liquid 32 from leaking.

The deposition method can be repeated a plurality times, as long as the amount of liquid 32 contained in the inner volume 117 is not exhausted.

FIG. 6 shows an alternative of said deposition method, which is performed without putting said point 113 in contact with said deposition surface 51. This can be very useful, in particular to prevent contamination of said point 113 with a liquid already present on said deposition surface 51. The device 100 is positioned on the deposition surface 51, at the vertical of the point where a predetermined amount of said liquid 32 is to be deposited, as shown in FIG. 5A.

An electrical current pulse I(t) is then injected into the solenoid 127 to create a magnetic field H(t) so as to temporarily lift said point 113 and thus open the passage 115. The combined effect of the weight and the plunger effect induced by the return of the rod 111 to its fully forward rest position enable a drop 61 to be separated, wherein the volume of said drop is dependent on the surface tension and the density of said liquid 32, the wetability of the surface of said rod 111, said point 113 and said tube 101, the shape of said point 113 and the degree of opening of said passage 115. The control of this last parameter enables a predetermined amount of said liquid 32 to be deposited.

FIG. 7 shows the method for washing said device 100. After a liquid 32 is deposited, it is generally necessary to wash the inner surface of said tube 101, the outer surface of said rod 111 and said point 113 before drawing a different liquid, so as to prevent any contamination. The washing is performed by injecting a pressurised detergent liquid 71, such as deionised water or an appropriate solvent, through the port 119. The detergent liquid 71 is discharged by suction via the passage 115, held open by the contact between said point 106 and a surface 73.

FIG. 8 shows, in the form of a flow chart, an example of a control system that enables the degree of opening of said passage 115 to be controlled during the drawing or deposition of the liquid 32. For greater clarity, a detail of said device 100 is also shown in the figure. This control system is applicable in particular when the translation system 129 enables the point 113 to be pressed against the base 33 or the deposition surface 51 with a constant force F, which can optionally be zero in the cases of the drawing method shown in FIGS. 4A to 4C and the contactless deposition method shown in FIG. 6. The relative position Z_{c} of the rod 111 with respect to the outer tube 101 is determined by the balance between said force F and the elastic force exerted jointly on said rod 111 by the spring 123 and the magnetic field created by the solenoid 127:
F=kZₑ=[kᵣ+kₘ(I)]Zₑ
where k, and kₘ(I) are the elastic constants of said spring 123 and the magnetic force, with the latter being a function of the current I that passes through the solenoid 127.

As the force F and the elastic constant kᵣ cannot be modified, the current I is the parameter that makes it possible to adjust the amount of said liquid 32 to be drawn or deposited, by controlling the degree of opening of said passage 115.

In step 81, the value Zₑ is determined by a measurement of the inductance L of said solenoid 127.

In step 83, Zₑ is compared to the target value Z_{c}, corresponding to the desired degree of opening of the passage 115.

In step 85, the current I is modified so as to increase or decrease the current I, which modifies the position Zₑ by means of kₘ(I).

In reference to FIG. 9, a second control system is also shown in the form of a flow chart. This system makes it possible to control the degree of opening of said passage 115 when drawing and depositing the liquid 32.

As in the case shown in FIG. 8, a detail of said device 100 is also shown in the figure. This control system is applicable in particular when the translation system 129 enables the point 113 to be pressed against the base 33 or the deposition surface 51 with a constant force F. As in the previous case, the relative position Zₑ of the rod 111 with respect to the outer tube 101 is determined by the balance between said force F and the elastic force exerted on said rod 111:
F=kZₑ

However, as said force F is adjustable, it can also be used directly to control the degree of opening of said passage 115. In this case, the solenoid 127 is used only as a sensor, and not as an actuator. This control system does not apply to the methods shown in FIGS. 4A-C and 6.

In step 91, the value Zₑ is determined by a measurement of the inductance L of said solenoid 127.

In step 93, Zₑ is compared to the target value Z_{c}, corresponding to the desired degree of opening of the passage 115.

In step 95, said adjustable force F is modified so as to bring Zₑ and Z_{c} closer together.

It is important to understand that the examples described and shown are given solely for the purpose of illustrating the subject matter of the invention, and in no way constitute a limitation thereof.

Thus, many modifications of specific embodiments of said devices shown in FIGS. 1A, 1B, 2A, 2B and 2C are possible without going beyond the scope of the invention, such as, for example:
the terminal portion may gradually narrow or, alternatively, may not exist;
said point may be not conical but, for example, pyramid-shaped, frusto-conical, ellipsoid, etc; it may also have flutes or grooves;
said ball may be in direct contact with the rod, without the spring; in this case, said spring advantageously connects the rod to the tube;
as the properties of wetability of the inner surface of the tube, said rods and said point play an important role in the drawing and deposition of said liquid, hydrophilic or hydrophobic coatings can be provided; in particular, said surfaces can include a coating made of a hydrophilic material such as tungsten;
said surfaces may also have protective coatings;
a plurality of materials may be used to produce said devices, in particular stainless steel, plastic materials or glass;
the solenoid can be replaced by any type of electrical, optical, mechanical or electromagnetic sensor and actuator; for example, it is possible to use, as sensors, capacitive sensors, strain gauges, piezoelectric or potentiometric sensors, photoelectric cells, etc., and, as actuators, electric motors, pneumatic, piezoelectric or thermal actuators, etc; in such a case, it is not necessary for the cylinder or said rod to be made of a magnetic material;
it is also possible for said devices not to have any sensor or actuator;
the solenoid can also replace the means for applying a force; in this case, the electromagnetic force replaces the elastic force;
the cylinder made of a magnetic material can be absent; in this case, if the solenoid is present, said rod must itself be made of a magnetic material;
said means for applying an elastic force can also be made, for example, of blocks of an elastomer material, an elastic beam or membrane or pneumatic devices;
said means for applying a force can also be absent; in this case, the weight alone of said rods must be sufficient for said conical point to hermetically close said opening;
the translation system can, for example, be based on a polar coordinate system;
the translation system can be controlled manually by means of micrometric screws;
said devices can be filled directly by the user or they can be provided in the form of pre-filled cartridges, to be disposed of or returned to the manufacturer after use; this is made possible by the fact that said means for applying a force hold said opening hermetically closed, and that the port, owing to its capillary size, does not enable the liquid contained in the inner volume to leak;
said devices can be provided with the port stopped, in which case they can be opened immediately before use;
although isolated devices have been described, it is possible to produce a drawing and deposit head composed of such devices, so as to be capable of simultaneously depositing an array of droplets of the same liquid or of different liquids;
in this case, it is advantageously possible to individually control the size of the droplets deposited by each of the devices constituting said drawing and deposit head, whereas the known systems of the prior art do not enable individual control of the size of the droplets.

1. Device for drawing and depositing droplets (100, 200) of at least one liquid (32), comprising:
an outer tube (101) with an opening (107) at one of its ends;
a flange (109) defining said opening (107);
a rod (111, 211, 221) capable of sliding inside said outer tube (101);
an inner volume (117) between said rod (111, 211, 221) and the outer tube (101);
a capillary-sized port (119) open in the wall of said outer tube (101), so that a pressure equal to that outside said port (119) is established in the inner volume (117);
an element for closing (113, 213) said opening (107) connected to said rod (111, 211, 221), and in which, when said rod (111, 211, 221) is in a forward end position, said closure element (113, 213) comes into contact with the flange (109) and thus hermetically closes said opening (107) while, when the rod is not in this end position, a capillary-sized passage (115) enables the inner volume (117) to communicate with the outside.

2. Device according to claim 1, wherein the maximum cross-section of said passage (115) is on the order of 10⁻⁸ m² with an uncertainty on the order of 1%, so that the volume of the deposited droplets is on the order of a nanoliter with an uncertainty on the order of 10 picoliters.

3. Device according to claim 1, wherein said closure element (113) is held in said fully forward position by means for applying an elastic force (123, 223).

4. Device according claim 1, wherein the cross-section of said passage (115) varies continuously on the basis of a relative position (Z) of said rod (111, 211, 221) with respect to said outer tube (101), between 0 and a maximum value, reached when said rod (111, 211, 221) is in said fully retracted position.

5. Device according to claim 1, wherein said closure element is a point (113).

6. Device according to claim 5, in which said point (113) is conical.

7. Device according to claim 1, wherein said closure element is a ball (213).

8. Device according to claim 3, wherein the means for applying an elastic force (123) is selected from a spring, an elastic beam, an elastic membrane, and a block of elastomer material.

9. Device according to claim 3, wherein the means for applying an elastic force (123) connect the end of the rod (111, 221) opposite the opening (107) to the outer tube (101).

10. Device according to claim 3, wherein the means for applying an elastic force (123) connect the end of the rod (211) opposite the opening (107) to a second rod (212), collinear to the first.

11. Device according to claim 9 or 10, wherein the closure element is secured to said rod (111, 211).

12. Device according to claims 1 to 8, wherein the means for applying an elastic force (123) connect the closure element to the end of the rod (221) on the side of the opening (107).

13. Device according to claim 4, wherein a position sensor (127) that enables the position (Z) of said rod (111, 211, 212, 221) inside said outer tube (101) to be measured.

14. Device according to claim 4, wherein an actuator (127) that enables the position (Z) of said rod (111, 211, 212, 221) inside said outer tube (101) to be adjusted.

15. Device according to claims 13 and 14, wherein the sensor (127) and the actuator (127) are constituted by a solenoid (127) and at least one portion of said rod (113) made of a material having a relative magnetic permeability μᵣ substantially greater than 1.

16. Device according to claim 1, consisting at least partially of a material selected from a metal including stainless steel, glass, a plastic material and a polymer.

17. Device according to claim 1, wherein protective coatings on at least one portion of the surfaces are capable of coming into contact with at least one liquid (32) to be drawn or deposited, respectively.

18. Device according to claim 1, wherein hydrophobic coatings on at least one portion of the surfaces are capable of coming into contact with at least one liquid (32) to be drawn or deposited.

19. Device according to claim 1, wherein hydrophilic coatings on at least one portion of the surfaces are capable of coming into contact with at least one liquid (32) to be drawn or deposited.

20. Device according to claim 19, wherein in that at least one of said coatings consists of a hydrophilic material such as tungsten.

21. Device according to claim 1, wherein the capillary-sized port (119) is too small to enable a liquid (32) capable of being drawn or deposited from passing through it.

22. Device according to claim 1, wherein the capillary-sized port (119) enables the inner volume (117) to communicate with the atmosphere.

23. Device according to claim, wherein the capillary-sized port (119) is connected to a container (219) containing an inert gas.

24. Device according to claim 23, wherein the pressure of the inert gas in the container (219) can be adjusted so that it is possible to draw or deposit a liquid (32) with the assistance of the pneumatic effect.

25. Device according to claim 1, wherein the capillary-sized port (119) can be stopped so as to insulate the inner volume (117) from the environment.

26. Device according to claim 1, wherein said device is attached to a translation system (129) enabling it to be moved in the three dimensions with micrometric precision.

27. Device according to claim 26, wherein the translation system (129) is controlled by a computer (131).

28. Device according to claim 1, wherein said device is constituted by a cartridge pre-filled with a liquid (32).

29. Drawing and deposit head consisting of a plurality of drawing and deposit devices (100, 200) according claim 1, for depositing an array of droplets of at least one liquid (32).

30. Drawing and deposit head according to the previous claim, wherein the amount of said liquid (32) drawn or deposited by each device (100, 200) belonging to said drawing and deposit head can be controlled individually.

31. Method for drawing at least one liquid (32) using a device (100, 200) according to claim 1, comprising at least the following steps:
(a) immersing said device (100) in a container (31) containing the liquid (32);
(b) retracting said closure element (113, 212) so as to open the passage (115), and filling said inner volume (117) by means of hydrostatic pressure and capillarity; and
(c) extracting said device (100) and moving said closure element (113, 213) forward so as to close the passage (115).

32. Method for drawing at least one liquid (32) according to claim 31, wherein the retraction of said closure element (113, 213) is caused by the pressure exerted by said closure element (113, 213) on the base (33) of said container (31).

33. Method for drawing at least one liquid (32) according to claim 31, wherein the retraction of said closure element (113, 213) is caused by the actuator (127).

34. Method for drawing at least one liquid (32) according to claim 31, additionally comprising at least the following steps:
(d) moving said opening (107) at the end of said device (100) toward the surface of said liquid (32) to be drawn;
(e) retracting said closure element (113, 213) by the actuator (127) so as to open the passage (115), and filling said inner volume (117) by means of capillarity forces alone.

35. Method for drawing at least one liquid (32) according to claim 34, in which the liquid (32) is contained in a microwell.

36. Method for drawing at least one liquid (32) according to one of claims 34 or 35, wherein the amount of said liquid (32) that is drawn is controlled by a position adjusting (Z) of said rod (111, 211) inside said outer tube (101), and, consequently, the cross-section of said passage (115).

37. Method for deposition by contacting a liquid (32) according to claim 34, additionally comprising at least the following steps:
(f) positioning said device (100, 200) at the vertical of the point of the deposition surface (51) where the deposit is to be provided;
(g) placing said closure element (113, 213) in contact with said deposition surface (51), and opening said passage (115) by means of the pressure exerted by said closure element (113, 213) on said contact surface (51);
(h) depositing a controlled amount (53) of said liquid (32) by means of the combined forces of adhesion of said liquid (32) to the deposition surface, capillarity and weight; and
(i) lifting said device (100, 200) and moving said closure element (113, 213) forward so as to close the passage (115).

38. Contactless method for depositing at least one liquid (32) according to claim 37, additionally comprising at least the following steps:
(j) positioning said device (100) at the vertical of the point of the deposition surface (51) where the deposit is to be provided;
(k) retraction of said closure element (113, 213) by means of said actuator (127), which causes said passage (115) to open; and
(l) moving said closure element (113, 213) forward so as to close the passage (115), and depositing a droplet (61) of said liquid (32) by means of the combined effect of the weight and the plunger effect caused by the forward movement of said closure element (113, 213).

39. Method for depositing at least one liquid (32) according to one of claim 37 or 38, wherein the amount of said liquid (32) that is deposited is controlled by adjusting the position (Z) of said rod (111, 211, 212, 221) inside said outer tube (101), and, consequently, the cross-section of said passage (115).

40. Method for washing a device (100, 200) according to claim 1, consisting of injecting, into said device, a pressurised detergent liquid (71) through the port (119), with said detergent liquid (71) being removed by suction via the passage (115), held open by retracting said closure element (113, 213).

41. Control system for adjusting the amount of liquid drawn or deposited by a method according to one of claims 31 to 39, wherein the translation system (129) presses said closure element (113, 213) against the base (33) or said deposition surface (33) with a constant force F, which can optionally be zero, and in that the relative position (Zₑ) of said rod (111, 211, 212, 221) with respect to said outer tube (101) is determined by the sensor (127), said relative position (Zₑ) is compared to its target value (Z_{c}), calculated on the basis of the amount of liquid (32) to be drawn or deposited, and the actuator (127) brings said relative position (Zₑ) close to said target value (Z_{c}).

42. Control system for adjusting the amount of liquid drawn or deposited by a method according to one of claims 31, 32, 36 and 37, wherein the translation system (129) presses said closure element (113, 213) against the base (33) or said deposition surface (33) with a variable force F, and in that the relative position (Zₑ) of said rod (111, 211, 212, 221) with respect to said outer tube (101) is determined by the sensor (127), said relative position (Zₑ) is compared to its target value (Z_{c}), calculated on the basis of the amount of liquid (32) to be drawn or deposited, and the translation system (129) brings said relative position (Zₑ) close to said target value (Z_{c}).
